(19) United States
(12) Patent Application Publication
(10) Pub. No.: US 2009/0300548 A1
(43) Pub. Date: Dec. 3, 2009

(54) Multi-Display Window with Scroll Ring Input

(75) Inventors: Michael Sullivan, Chandler, AZ (US); Troy Liebl, Owatonna, MN (US); Edward Lipscomb, Lakeville, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation, Charlotte, NC (US)

(21) Appl. No.: 12/476,958

(22) Filed: Jun. 2, 2009

Related U.S. Application Data
(60) Provisional application No. 61/058,040, filed on Jun. 2, 2008.

(51) Int. Cl. G06F 3/048

(52) U.S. Cl. 715/830

(57) ABSTRACT

A graphical user interface for a portable diagnostic device includes a first window area in which a navigation bar is displayed, a second window area in which data list items are displayed and a wheel menu, selectively overlaying at least a portion of the first and second window areas, in which menu items are displayed. The data list items are selected in response to commands received from a first scroll ring input device, while the menu items are selected in response to commands received from a second scroll ring input device.

### CROSS-REFERENCE TO RELATED APPLICATIONS

This application claims the benefit of U.S. Provisional Application No. 61/058,040, filed on Jun. 2, 2008, entitled “Multi-Display Window With Scroll Ring Input,” which is hereby incorporated by reference in its entirety.

### FIELD OF THE INVENTION

The present invention relates generally to a graphical user interface. More particularly, the present invention relates to a multi-display window with scroll ring input.

### BACKGROUND OF THE INVENTION

Generally, portable diagnostic devices communicate with embedded, computer-based systems to collect and analyze telemetry and other data. These devices include, for example, vehicular diagnostic tools, which receive, analyze and display data from various sensors and processors installed within a modern vehicle. During these communications, data associated with particular sensors, components, subsystems, etc., such as, for example, anti-lock braking systems, air conditioning systems, transmissions, steering mechanisms, etc., are transferred to the vehicular diagnostic tool for analysis and display. Technicians use these data to diagnose off-nominal conditions, to determine whether repairs are needed, to determine whether additional diagnostic testing is necessary, etc.

Current vehicular diagnostic tools present these data to the technician using a graphical user interface that includes a window displayed on a small liquid crystal display (LCD) screen. The technician selects particular items from a sequence of menus using a keypad that includes at least two directional keys (e.g., up and down arrow keys) and a selection key (e.g., an enter key). This architecture offers limited flexibility with respect to data organization and presentation, and subjects the technician to a rather onerous navigation paradigm. For example, the technician must repeatedly select one of the direction keys in order to scroll through a long list of menu items.

Accordingly, it is desirable to provide a graphical user interface that improves organization and presentation efficiency, as well as navigation speed, for portable diagnostic devices.

### SUMMARY OF THE INVENTION

Embodiments of the present invention provide a graphical user interface for a portable diagnostic device. The graphical user interface includes a first window area to display a navigation bar, a second window area to display a data list having a plurality of selectable items, and a wheel menu, having a first position selectively overlaying at least a portion of the first and second window areas, to display a plurality of selectable menu items. The menu items of the wheel menu are selected in response to commands received from a left scroll ring input device when overlaying the portions of the window areas.

Other embodiments of the present invention provide a method for displaying a graphical user interface for a portable diagnostic device. The method involves displaying a first window area, a second window area, and a wheel menu including menu items that when displayed, in a first position, selectively overlays at least a portion of the first and second window areas. Also part of the method is receiving input signals from a left scroll ring input device for manipulating the graphical user interface. A first input signal from the left scroll ring input device causes the portable diagnostic device to respond by scrolling through menu items of the wheel menu and indicating focus on one menu item. A second input signal from the left scroll ring input device causes the portable diagnostic device to respond by selecting a first menu layer item and displaying a second layer of menu items within the wheel menu along with and visually distinguished from the first layer menu items. A third input signal from the left scroll ring input device causes the portable diagnostic device to respond by moving the wheel menu from the first position to a second position and displaying a navigation bar in the first window area of the display and a data list in the second window area of the display.

Further embodiments of the current invention include a portable diagnostic device including a display to present a graphical user interface. The graphical user interface includes a first window area having a navigation bar, a second window area having a data list, and a wheel menu that when displayed, in a first position, selectively overlays at least a portion of the first and second window areas and includes menu items. Also part of the portable diagnostic device is a first scroll ring input device to generate user input signals and selectively interact with the wheel menu and the navigation bar. A memory is included to store graphical user interface software instructions, and a processor to interpret the instructions stored on the memory and the user input signals generated by the first and second scroll ring input devices is also part of the device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 presents a schematic view of a portable diagnostic device, in accordance with an embodiment of the present invention.

FIGS. 2, 3 and 4 present front, bottom and top views, respectively, of a portable diagnostic device, in accordance with an embodiment of the present invention.

FIGS. 5 and 6 present perspective views of a portable diagnostic device, in accordance with an embodiment of the present invention.

FIG. 7 depicts two vehicle interface cables, in accordance with embodiments of the present invention.

FIGS. 8-26 illustrate various portions a graphical user interface, in accordance with embodiments of the present invention.

FIG. 27 presents a flowchart illustrating steps that may be followed to display a graphical user interface for a portable diagnostic device, in accordance with embodiments of the present invention.

### DETAILED DESCRIPTION

Embodiments of the present invention provide a graphical user interface for a portable diagnostic device. While various aspects of the present invention are discussed below in the context of a vehicular diagnostic tool, other architectures and applications are clearly contemplated. In this context, vehicles include automobiles, motorcycles, trucks, boats, planes, helicopters, agricultural equipment (e.g., harvesters), construction equipment (e.g., excavators), etc.

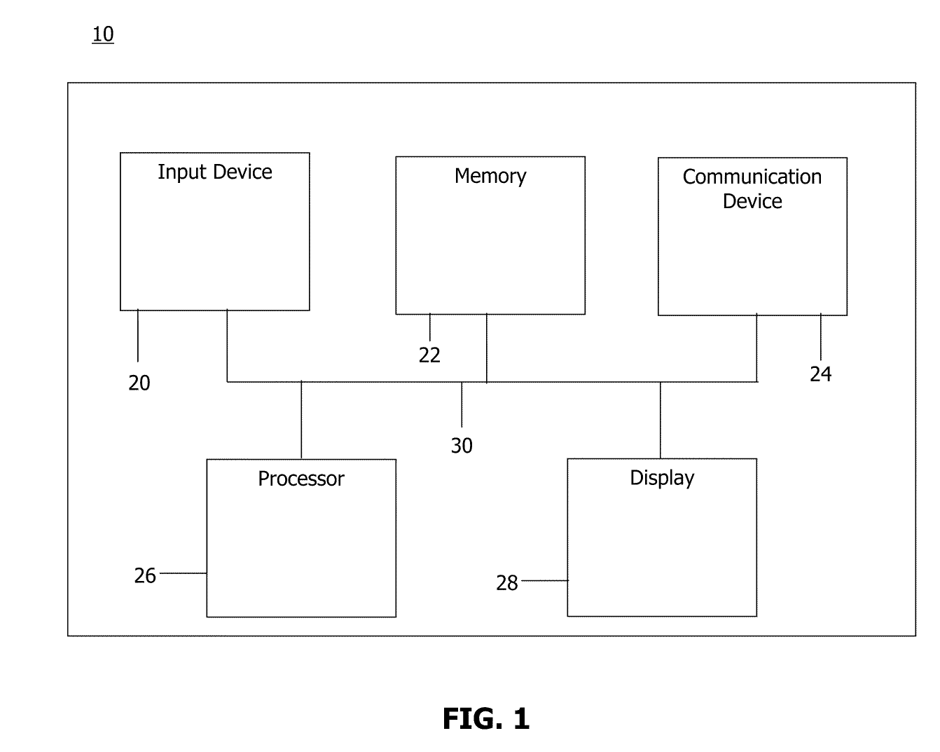

The invention will now be described with reference to the drawing figures, in which like reference numerals refer to like parts throughout. An embodiment of the portable diagnostic device is illustrated in FIG. 1. The portable diagnostic device 10 includes an input device 20, a memory 22, a communication device 24, a processor 26, and a display 28, all of which are interconnected by a data link 30. The portable diagnostic device 10 can be, for example, a general computer, such as a personal computer (PC), a UNIX workstation, a server, a mainframe computer, a personal digital assistant (PDA), or some combination of these. The remaining components include programming code, such as source code, object code or executable code, stored on a computer-readable medium that is loaded into the memory 22 and processed by the processor 26, respectively, in order to perform the desired functions.

In various embodiments, portable diagnostic device 10 can be coupled to a communication network 60, which can include any viable combination of devices and systems capable of linking computer-based systems, such as the Internet; an intranet or extranet; a local area network (LAN); a wide area network (WAN); a direct cable connection; a private network; a public network; an Ethernet-based system; a token ring; a value-added network; a telephony-based system, including, for example, T1 or E1 devices; an Asynchronous Transfer Mode (ATM) network; a wired system; a wireless system; an optical system; a combination of any number of distributed processing networks or systems or the like. The communication network 50 allows for portable diagnostic device 10 and another device, such as a vehicle communication interface to send and receive information.

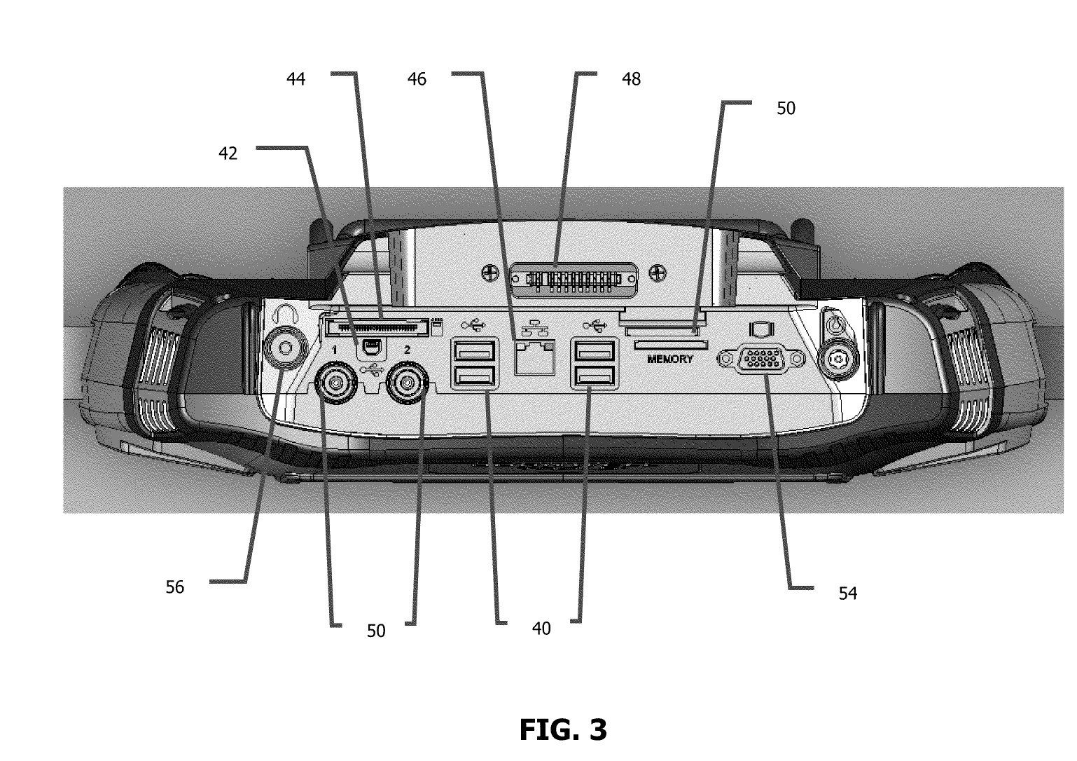

The portable diagnostic device 10 can be coupled to the communication network 60 by way of the communication device 24, which in various embodiments can incorporate any combination of devices—as well as any associated software or firmware-configured to couple processor-based systems, such as modems, network interface cards, serial buses, parallel buses, LAN or WAN interfaces, wireless or optical interfaces and the like, along with any associated transmission protocols, as may be desired or required by the design. The communication device 24 may include, as depicted in FIG. 3, a universal serial bus (USB) connector 40, and USB device connector 42, an Ethernet connector 46, vehicle cable connector 48, a secure digital input output card interface (SDIO) 50, a channel scope BNC connector 52, and/or a VGA video output connector 54.

The communication device 24 and communication network 50 may be used to provide software updates to the portable diagnostic device 10, for example, via the internet. Alternatively, software updates may be provided via physical media, such as on CD, DVD, or USB connected external memory device. This and other memory requiring functions may also be accomplished through expansion ports 32 that may be included in the portable diagnostic device 10, such as an express card interface 44 or the SDIO card interface 50.

In one embodiment, a digital oscilloscope/digital multi-meter may be incorporated within the vehicular diagnostic tool itself, while in another embodiment, the digital oscilloscope/digital multi-meter may be an external device, such as, for example, a USB device or a device connected to the portable diagnostic device 10 via the channel scope BNC connector 52.

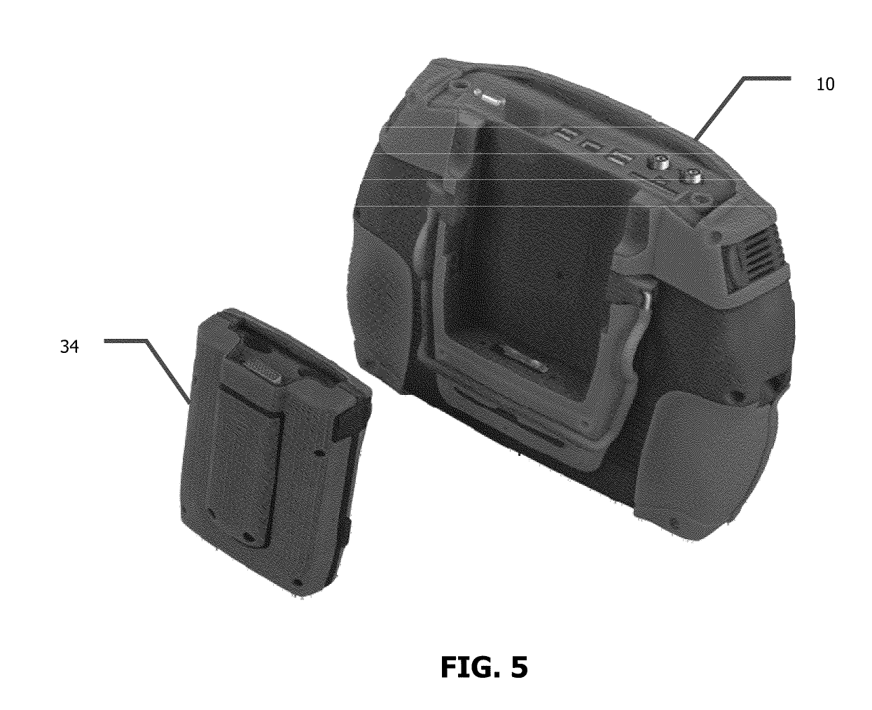

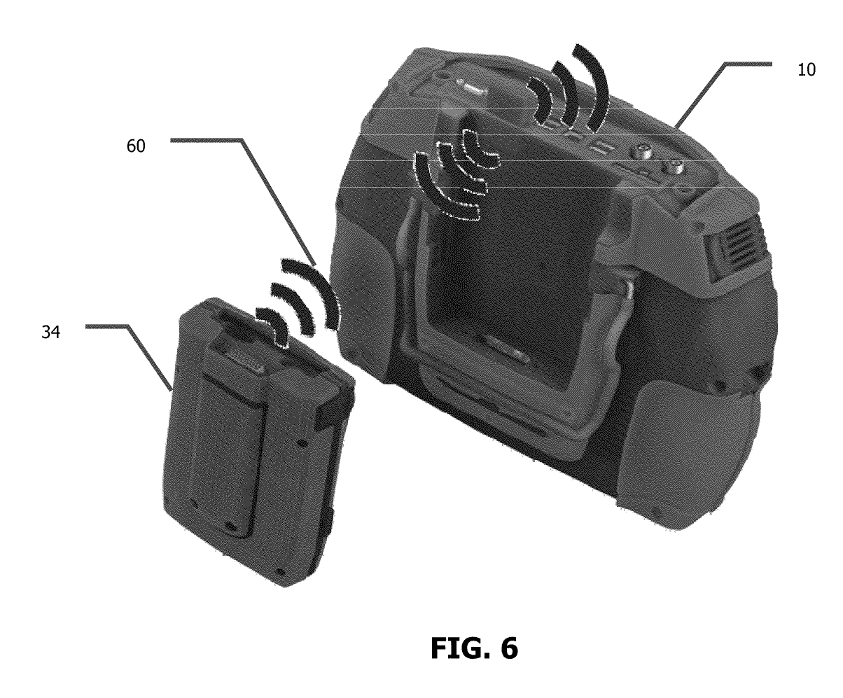

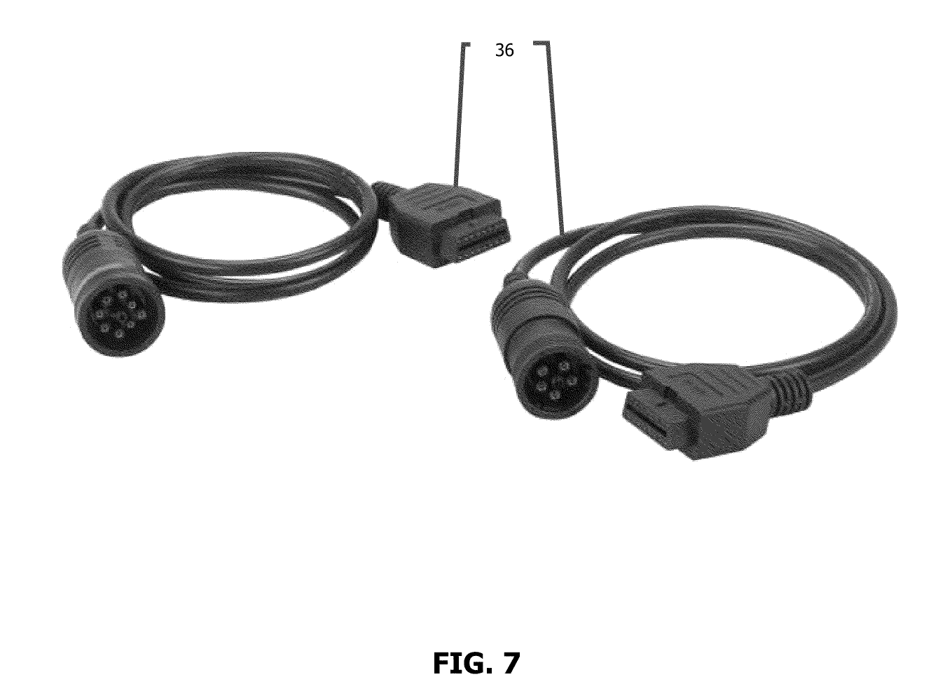

A Vehicle Communications Interface 34 (VCI) may be included with the portable diagnostic device 10 as a removable module that uses a dedicated cable 36 to connect to a vehicle, translates the vehicle communication and data protocols and may include wireless connectivity. Either of these methods of communication between the portable diagnostic device 10 and the VCI 34 may be accomplished over the communication network 60. See, FIGS. 5-7.

Additionally, an embodiment of the portable diagnostic device 10 may communicate information to the user through the display 28 and request user input through the input device 20 by way of an interactive, menu-driven, visual display-based user interface, or graphical user interface (GUI). The user interface may be executed, for example, on a personal computer (PC) with an input device 20, such as a mouse and keyboard, with which the user may interactively input information using direct manipulation of the GUI. Direct manipulation may include the use of a pointing device, such as a mouse or a stylus, to select from a variety of selectable fields, including selectable menus, drop-down menus, tabs, buttons, bullets, checkboxes, text boxes, and the like. Nevertheless, various embodiments of the invention may incorporate any number of additional functional user interface schemes in place of this interface scheme, with or without the use of a mouse or buttons or keys, including for example, a trackball, a scroll ring, a touch screen, or a voice-activated system.

Alternatively the portable diagnostic device 10 may communicate information to the user through speakers or a headset connected to a stereo headphone jack 56 on the portable diagnostic device 10. The input device 20 may be a microphone to accept user input as voice commands.

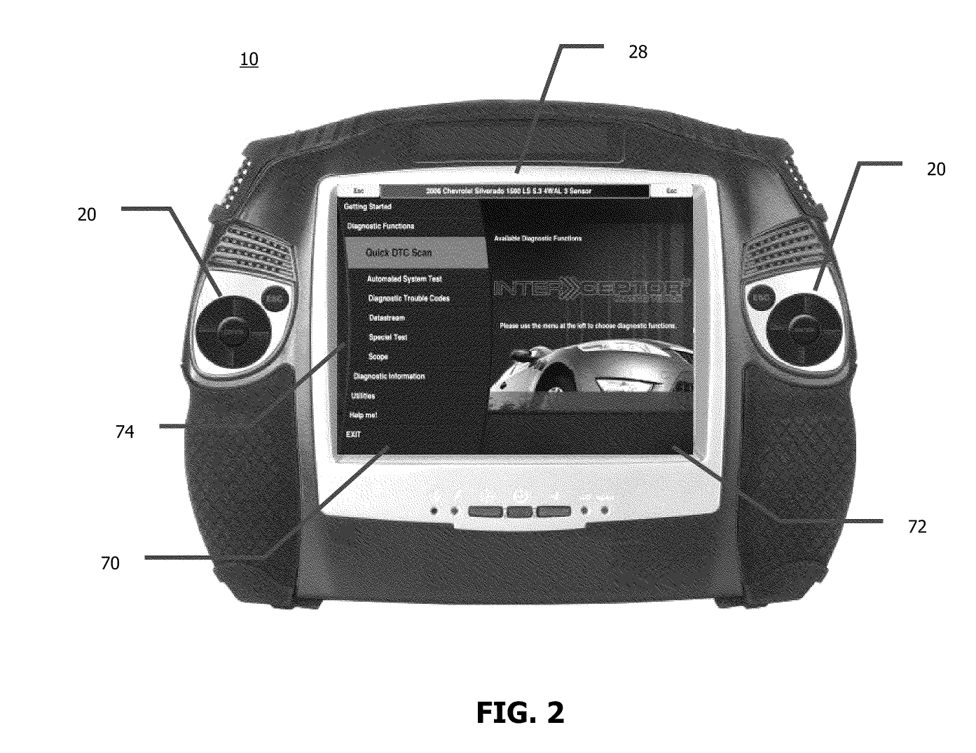

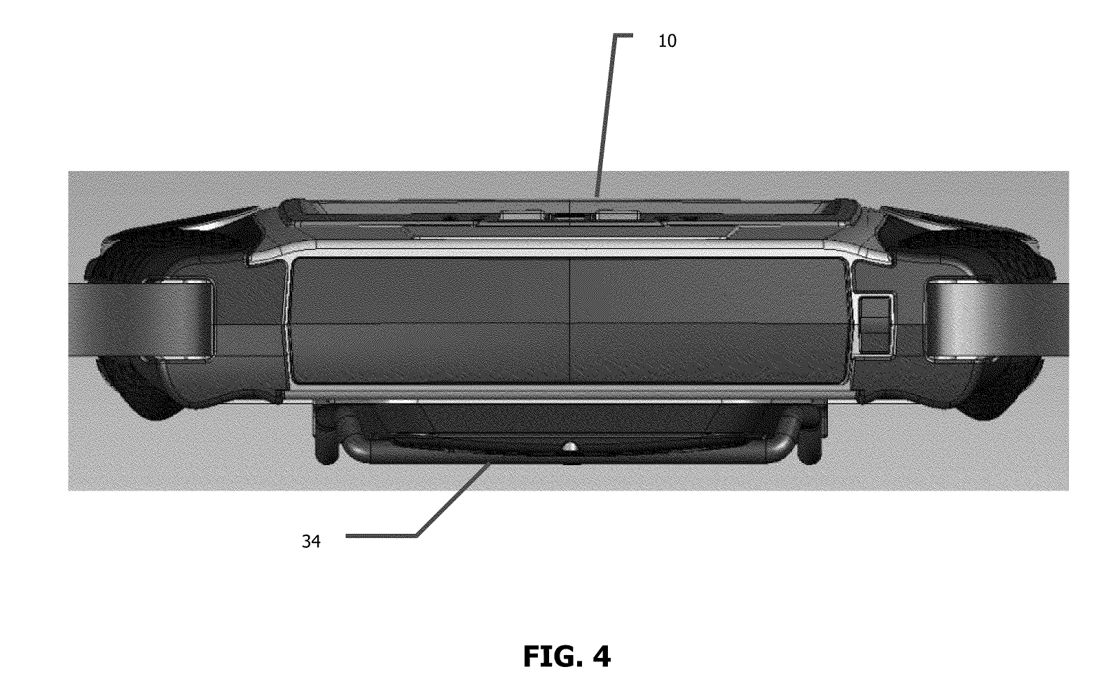

FIGS. 2-6 present several views of a portable diagnostic device 10 in the form of a vehicular diagnostic tool in accordance with embodiments of the present invention. The vehicular diagnostic tool includes, inter alia, a housing, a display 28 and a pair of scroll ring input devices 20 mounted adjacent to the display 28. Each scroll ring input device 20 includes a circular switch array that surrounds a central selection button (e.g., labeled “enter”), and may include an optional escape button (e.g., labeled “esc”) proximate to the circular switch array. Examples of scroll ring input devices 20 include the “SpeedScroll” (SPX Corporation), the “SimScroll” and the “SimTouch” (White Electronic Designs). In other embodiments, the display 28 may include a “touch-screen” feature to complement (or, alternatively, replace) the scroll ring input devices 20.

In various preferred embodiments, the left scroll ring input device 20 controls a Wheel Menu 70 that is displayed (e.g., overlaid) in the left portion of the window, while the right scroll ring input device 20 controls lists of data items 76 (“DataLists”) that are selectively displayed in a second window area 72. Additionally, the left scroll ring input 20 device controls navigation bars 78 (“NavBars”) that are selectively displayed in the first window area 74. In other embodiments, the right scroll ring input device 20 may also control NavBars that are displayed in the second window area 72. The DataLists 76 and NavBars 78 are displayed in response to particular Wheel Menu 70 selections, and are dynamic and contextual.

In one embodiment, when the NavBar 78 is displayed in the first window area 74, the Wheel Menu 70 is entirely removed from the window, while in another embodiment, the Wheel Menu 70 is reduced in width (e.g., completely or partially minimized) and displayed (e.g., overlaid) in the left-most portion of the window. Generally, the edges of the Wheel Menu 70 may be curved to complement the circular shape of the scroll ring input device 20.

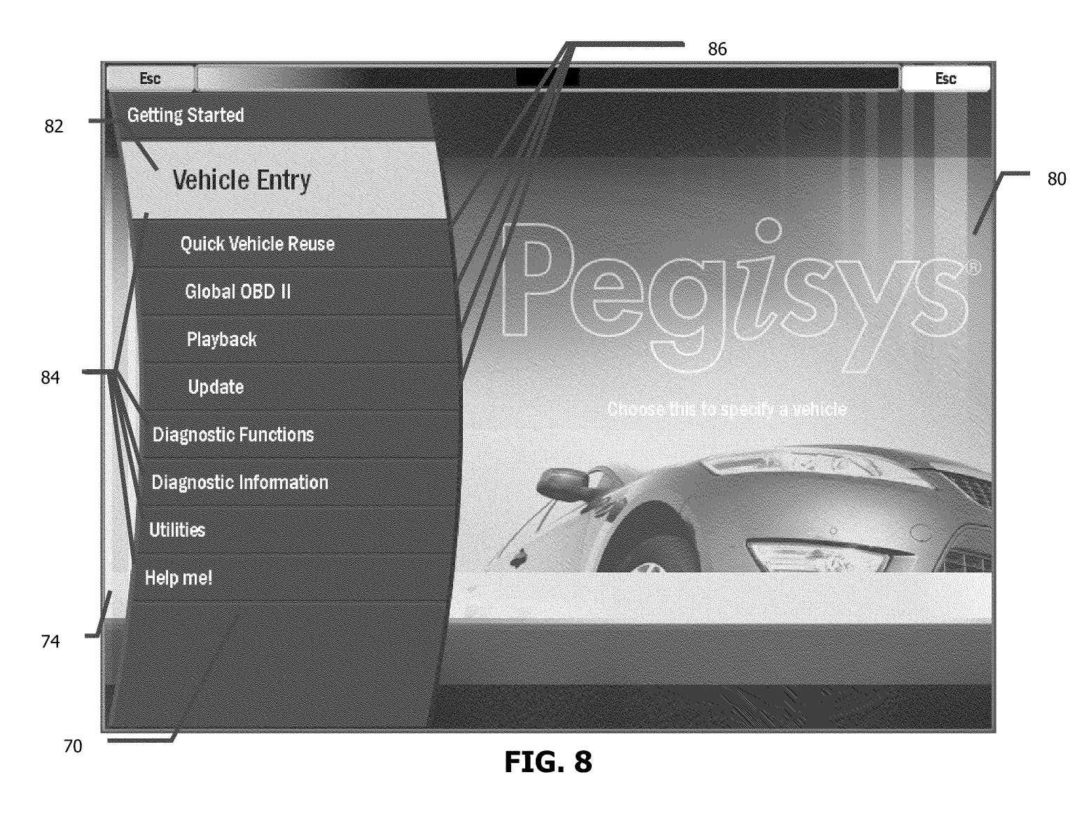

As shown in FIG. 2 et seq., the Wheel Menu 70 is displayed (e.g., overlaid) in the first window area 74. Prior to the initial selection of a menu item 82 from the Wheel Menu 70, or at various other times, an information screen 80 (“Info Screen”) is displayed in the window. In one embodiment, the Info Screen is a simple background, wallpaper or image, upon which messages related to the position of the selection bar within the Wheel Menu 70 may be displayed. For example, when the selection bar is positioned over the “Vehicle Entry” menu item, the message “Choose this to specify a vehicle” may be displayed within the Info Screen, as depicted in FIG. 8.

Generally, after selection of an appropriate menu item 82 in the Wheel Menu 70, the Wheel Menu 70 may be hidden or minimized and the Info Screen will be replaced, in whole or in part, by a DataList 76 and/or a NavBar 78. In a preferred embodiment, the Wheel Menu 70 is hierarchical in nature, and includes at least two layers. The items within the first menu layer 84 are located flush with the left edge of the Wheel Menu 70, while the visible portion of the second menu layer 86 is indented with respect to the first menu layer items 84.

In depicted embodiment, the first menu layer 84 includes one or more of the following menu items 82: “Getting Started,” Diagnostic Functions,” “Diagnostic Information,” “Utilities,” “Help Me!” and “Exit.” As depicted in FIG. 2, the visible portion of the second menu layer 86 represents those items associated with the “Diagnostic Functions” menu item, including “Quick DTC Scan,” Automated System Test,” Diagnostic Trouble Codes,” “Datastream,” “Special Test” and “Scope.” In one preferred embodiment, the Wheel Menu 70 simultaneously displays all of the items within the first menu layer 84 in combination with a selected portion of the items within the second menu layer 86. If sufficient space does not exist within the window to display all of the menu items 82 within the first or second layers, in one embodiment, the respective menu items 82 may scroll on and off the Wheel Menu 70. In one embodiment, scroll arrows may be located at the upper and lower edges to indicate off-window scrolling capabilities.

Rotating the left scroll ring in a clockwise or counterclockwise direction moves a selection bar up or down in the Wheel Menu 70, and depressing the center button selects the currently-highlighted item. In one embodiment, depressing the escape button hides or minimizes the Wheel Menu 70, revealing the Info Screen 80, NavBar 78 and/or DataList 76, or combinations thereof, lying underneath. Movement of the selection bar to a different first layer menu item 84 (e.g., “Diagnostic Information”) followed by the selection of that item will cause the second layer menu items 86 currently displayed (e.g., “Quick DTC Scan”, etc.) to be removed and the second layer menu items 86 associated with the new selection to be displayed. Alternatively, upon selection of a new first layer menu item 84, a DataList 76 may be displayed in the second window area 72 and/or a NavBar 78 may be displayed in the first window area 74.

The DataList 76 includes a list of data elements of various types, such as, for example, text, graphics, data graphs, etc. Rotating the right scroll ring in a clockwise or counterclockwise direction moves a selection bar up or down in the DataList 76, and depressing the center button selects the currently-highlighted item. In one embodiment, depressing the escape button provides a “Go Back” navigation function. Various permutations of this functionality are discussed below. Additionally, the graphical user interface may be selectively reversed for opposite-handed technicians, i.e., the Wheel Menu 70 may be overlaid on the second window area 72 and may respond to commands received from the right scroll ring input device 20, etc.

FIGS. 8-26 illustrate portions of a graphical user interface, in accordance with embodiments of the present invention.

FIG. 8 depicts those second layer menu items 86 associated with, and depending from, the “Getting Started” menu item (the “Vehicle Entry” menu item is highlighted). These second layer menu items 86 represent different avenues for entering vehicle information; generally, the technician chooses a previously used vehicle or specifies a new one.

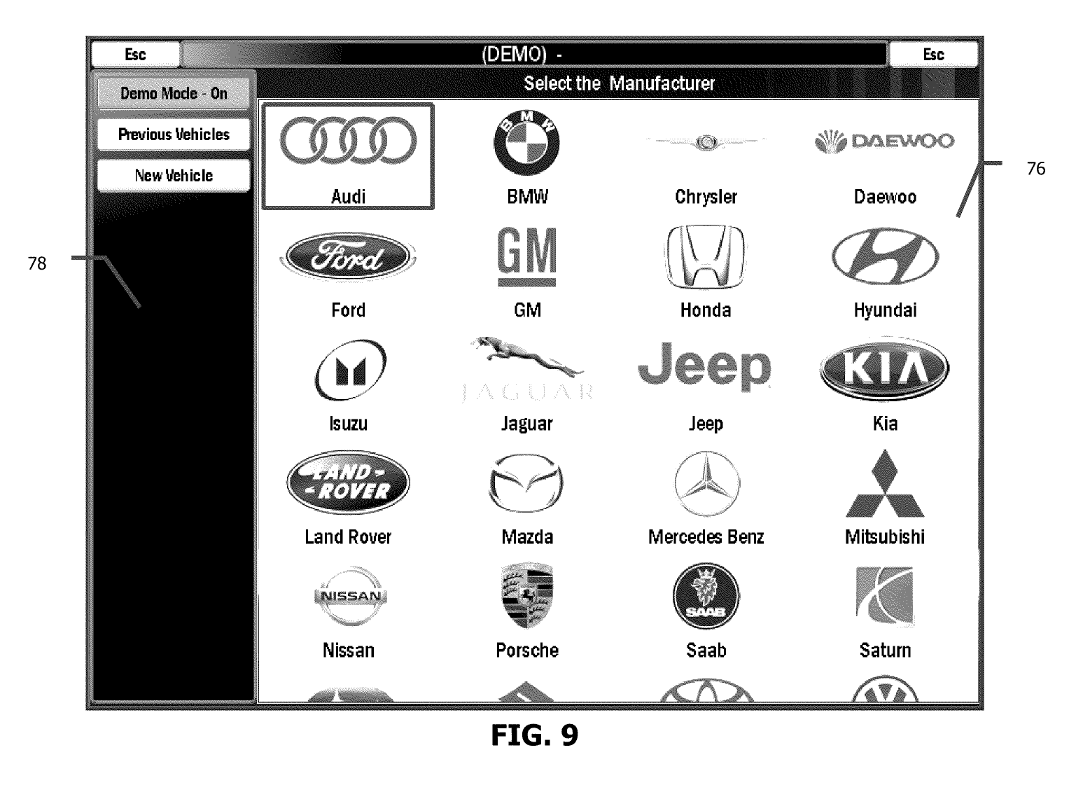

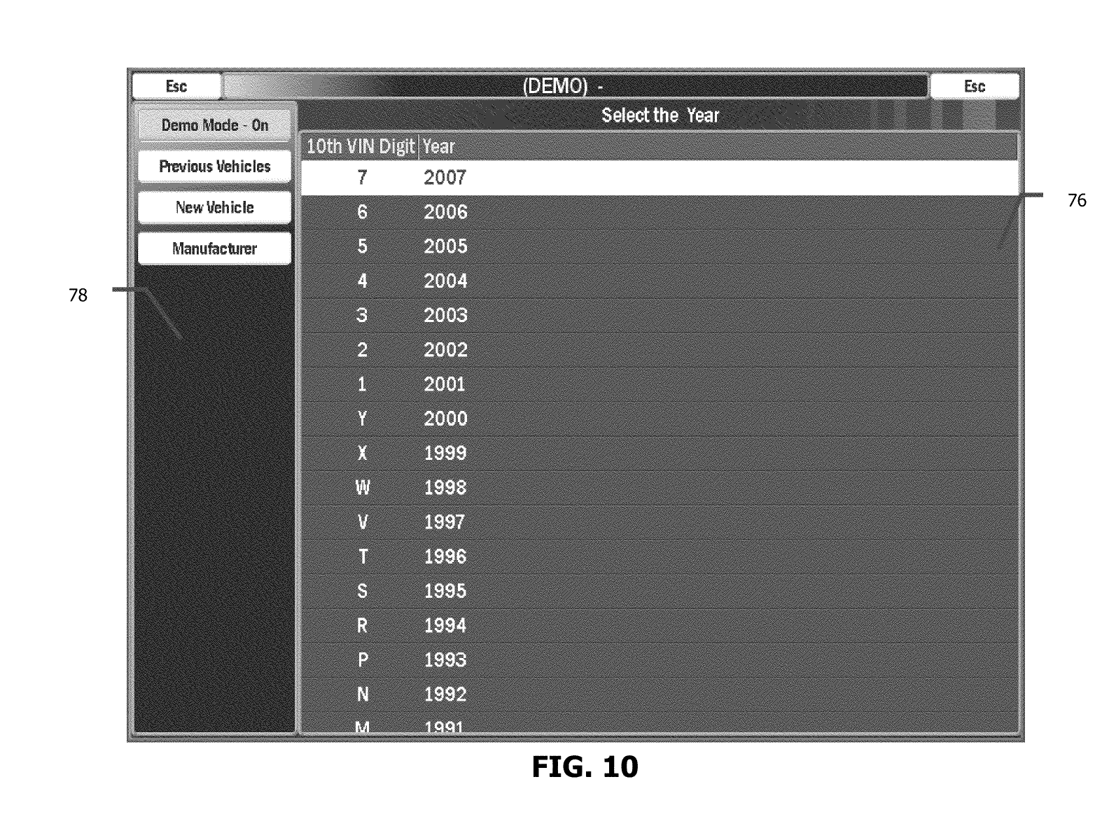

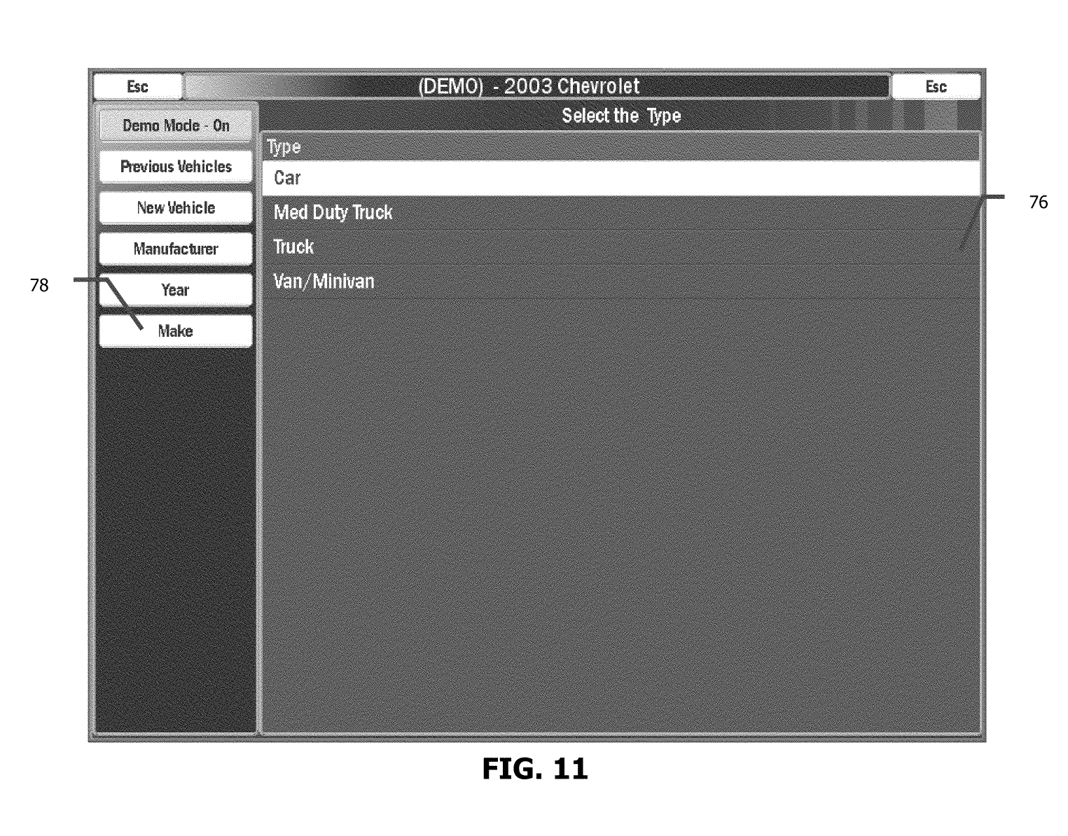

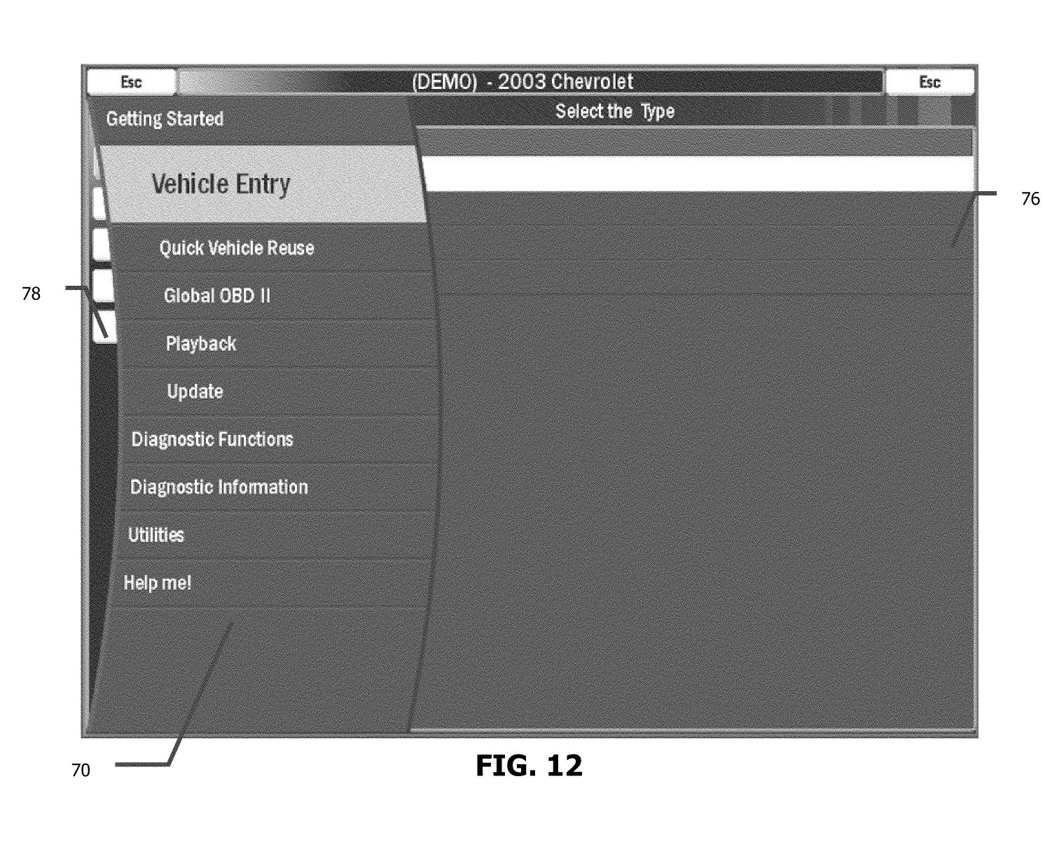

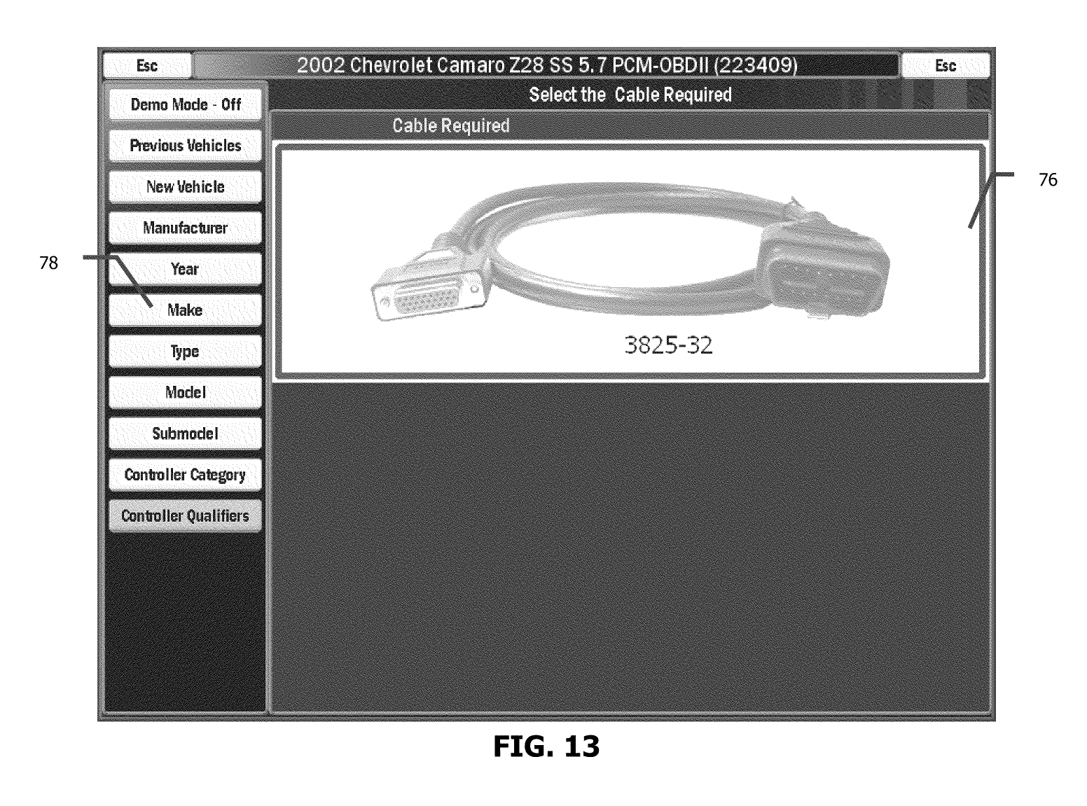

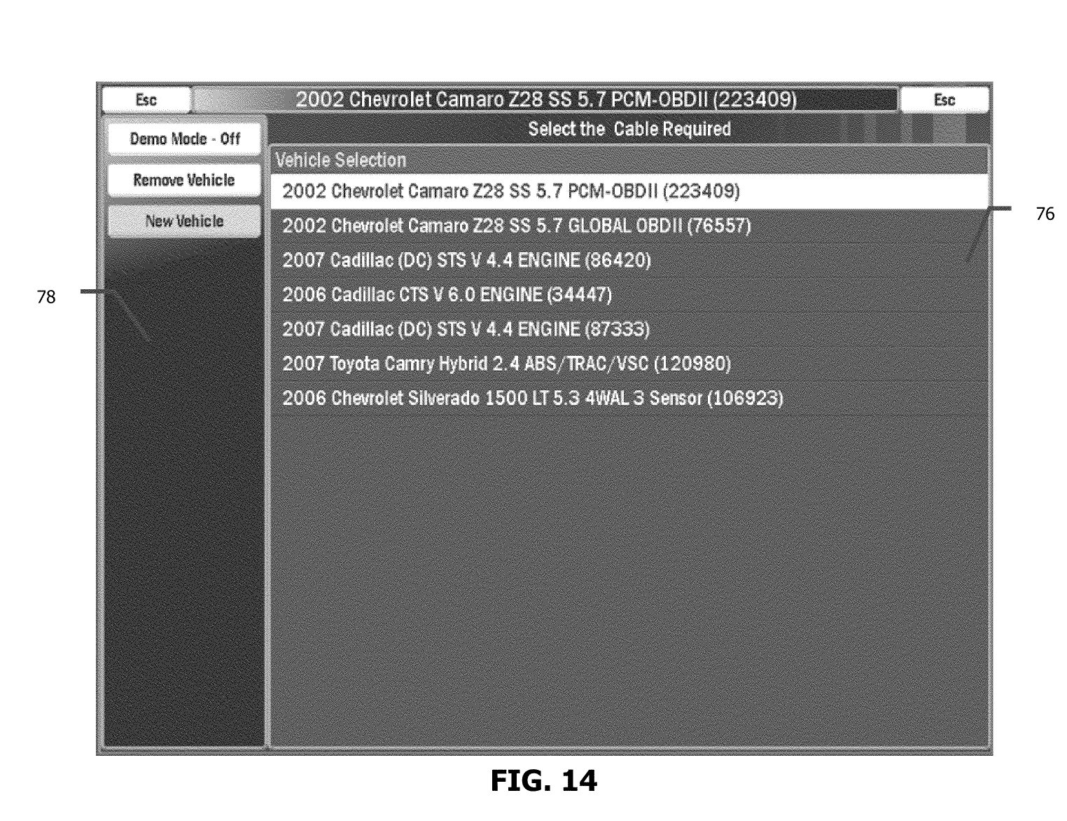

FIGS. 9-14 depict a series of NavBars 78 and DataLists 76 associated with the “Vehicle Entry” menu item selected in FIG. 8; this series of screens allows the technician to specify the vehicle to be tested. While the Wheel Menu 70 is hidden in FIGS. 9-11, 13, 14, it may be activated by the technician at any time. For example, FIG. 12 depicts an active Wheel Menu 70 that overlays portions of the NavBar 78 and the DataList 76. FIG. 9 depicts an example of a grid display of icons representing manufacturer logos, while FIG. 10 depicts a vertically-oriented DataList 76 in the second window area 72. The selection bar is moved up or down using the right scroll ring input device 20, and a particular item is selected using the right enter button, which results, for example, in the transition to the interface depicted in FIG. 11. As selections are made in FIGS. 9, 10 and 11, additional navigation buttons are added to the NavBar 78 displayed in the first window area 74 (i.e., “Manufacturer,” “Year,” “Make”). FIG. 13 depicts the NavBar 78 and DataList 76 associated with the selection of the interface cables required for the indentified vehicle. FIG. 14 depicts the DataList 76 associated with the selection of the NavBar button “Previous Vehicles” in FIG. 9.

FIG. 12 depicts a Wheel Menu 70 that has been activated during the vehicle selection process, thereby allowing the technician to select a different first or second layer menu item 84, 86, respectively, using the left scroll ring input device 20. The right scroll ring input device 20 still controls selection of the DataList 76, even though those items are not visible underneath the Wheel Menu 70.

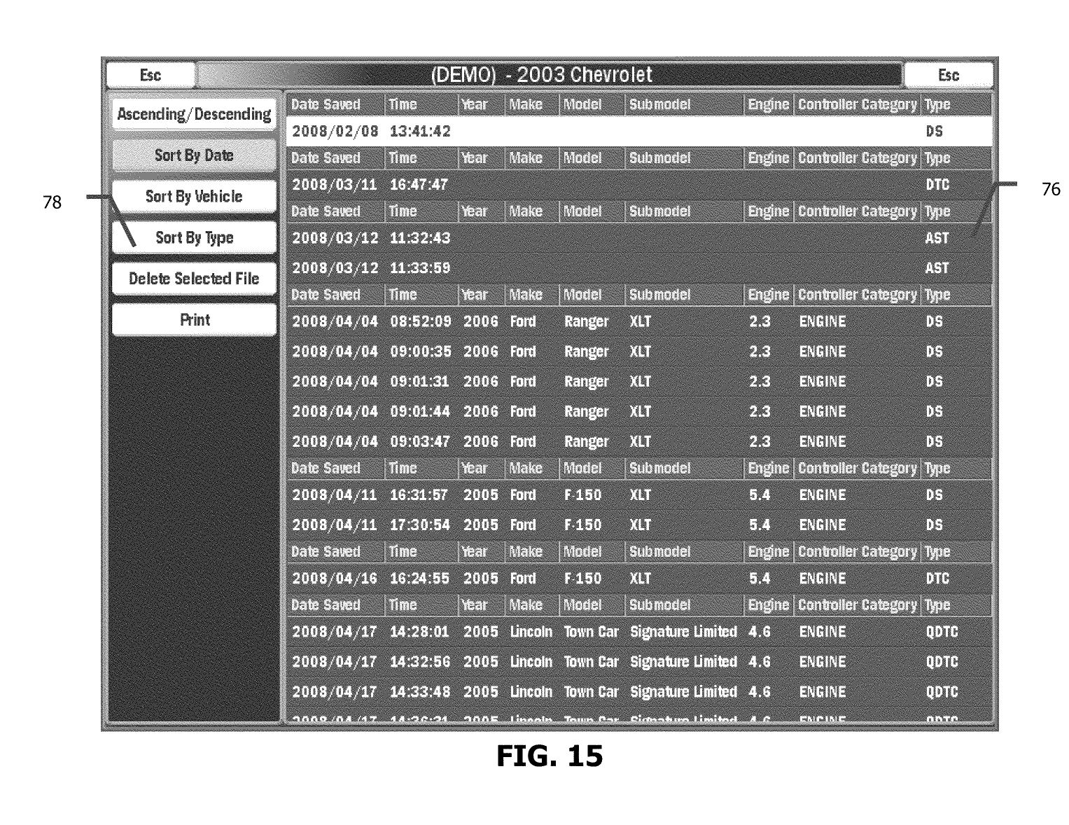

FIG. 15 displays a list of previously-saved “event” that can be redisplayed, accessed through one or more menu items 82, such as the “Playback” menu item depicted in FIG. 8.

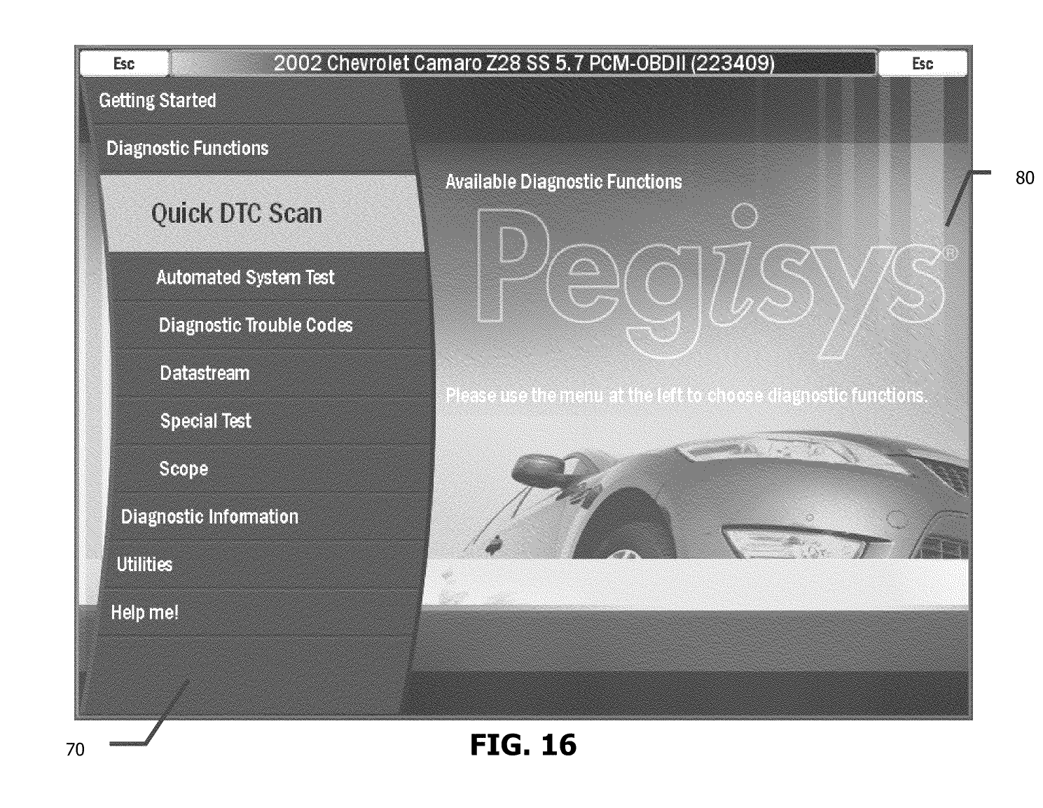

FIG. 16 depicts those second layer menu items 86 associated with, and depending from, the “Diagnostic Functions” menu item (the “Quick DTC Scan” menu item is highlighted). These second layer menu 86 items represent different diagnostic functions available to the technician, and, in one embodiment, the second layer menu items 86 may change depending upon the selected vehicle. For example, the “Special Test” diagnostic function may not be available for the chosen vehicle, and, thus, may not be displayed; alternatively, this function may be dimmed, etc.

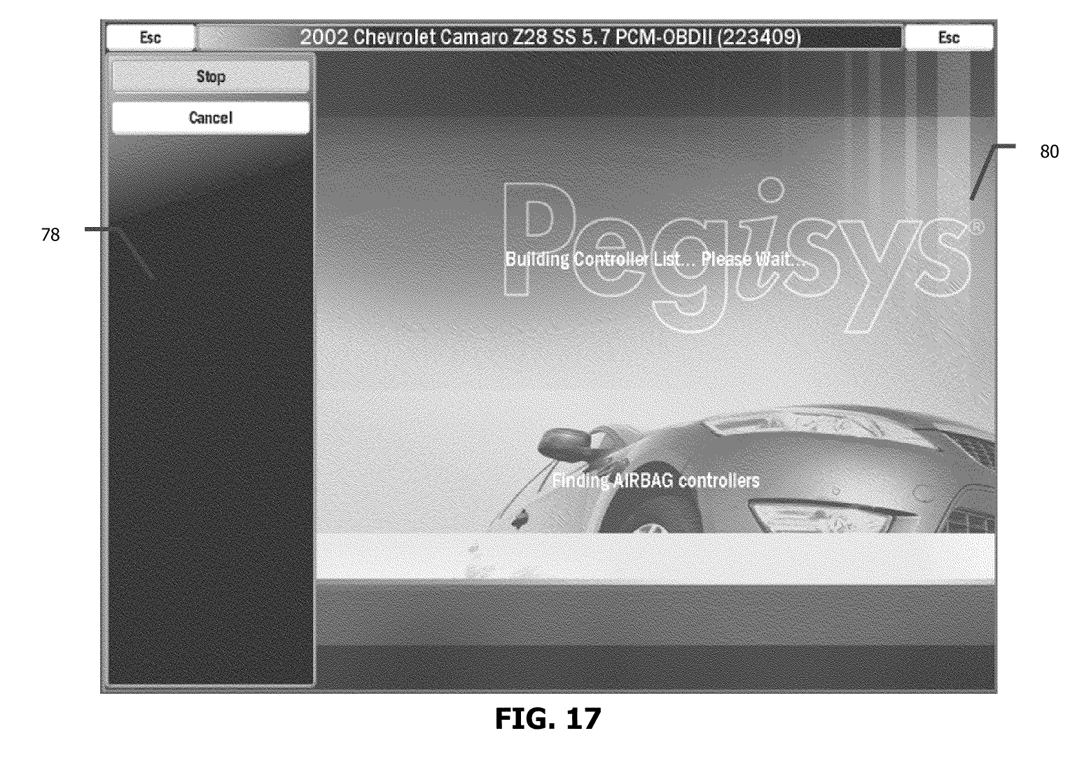

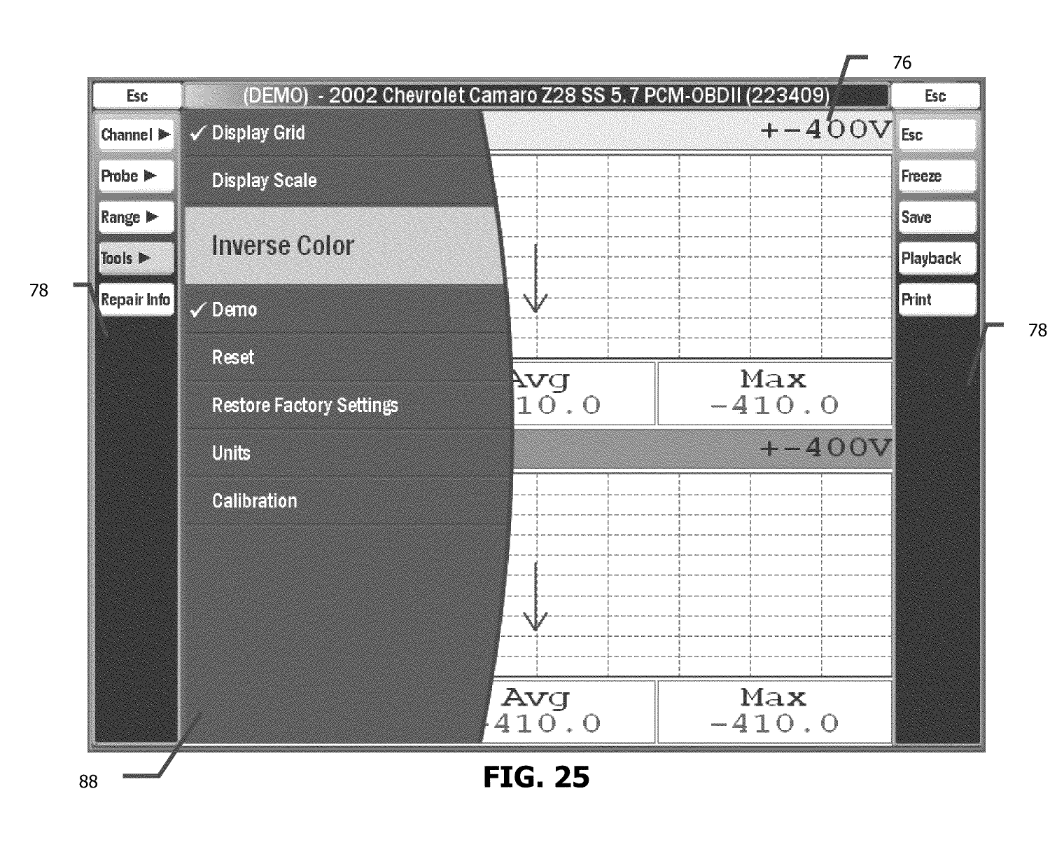

FIGS. 17-25 depict a series of NavBars 78, DataLists 76 and other features associated with the “Diagnostic Functions” menu item selected in FIG. 16; this series of screens generally depicts the diagnostic functions available to the technician. While the Wheel Menu 70 is hidden in FIGS. 17-25, it may be activated by the technician at any time. In a further embodiment, a second Wheel Menu 88, depicted in FIG. 25, may present additional options associated with the display in the central portion of the window.

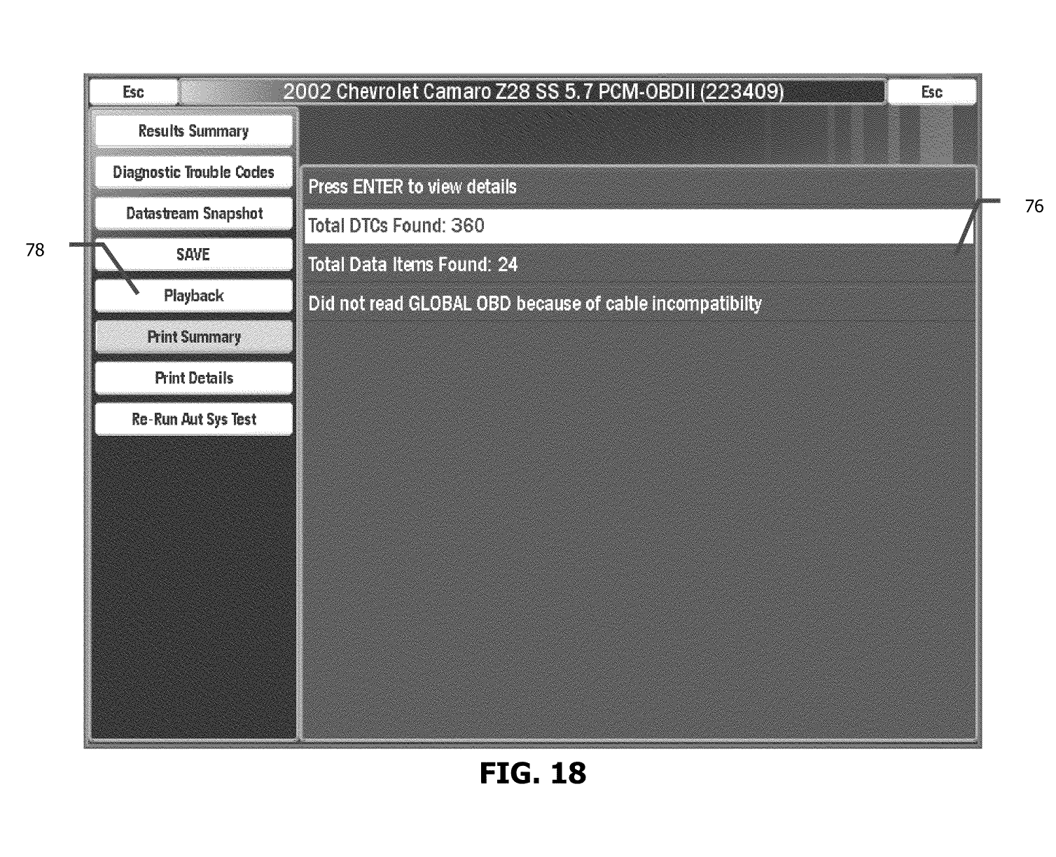

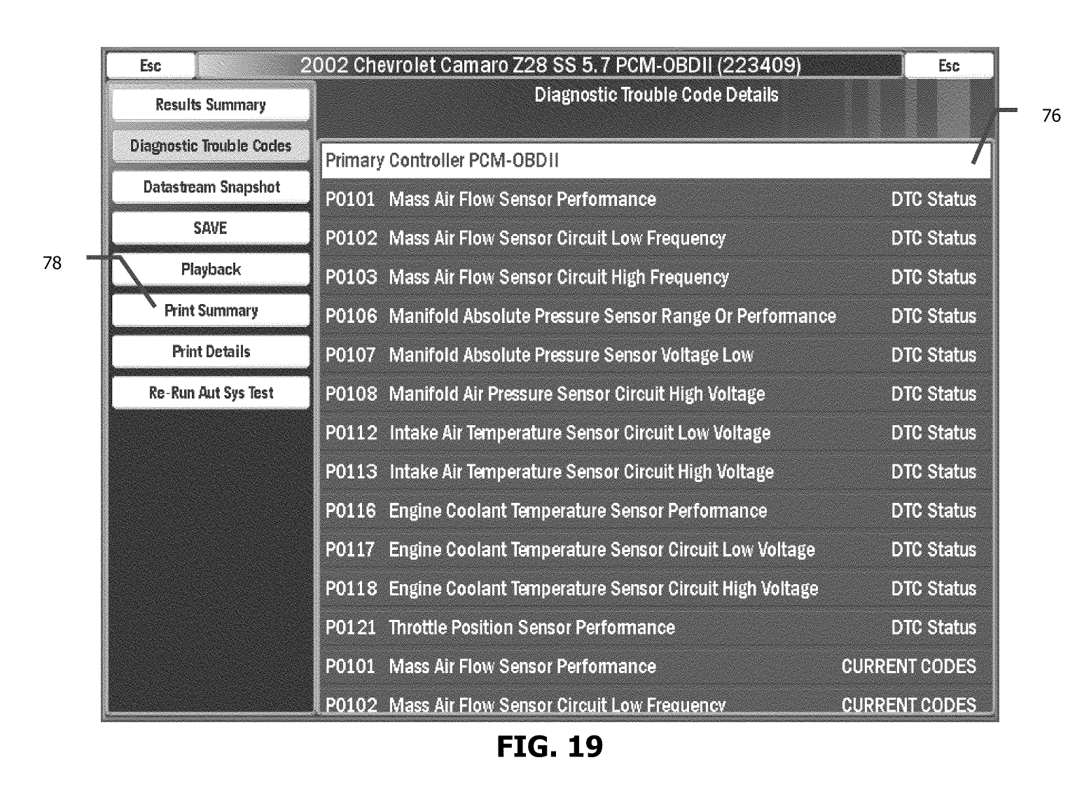

FIGS. 17, 18 and 19 illustrate NavBars 78, DataLists 76 and Info Screens 80 associated with the “Automated System Test” diagnostic function. FIG. 17 illustrates a NavBar 78 and Info Screen 80 that are displayed to the technician during an automated system test sequence, while FIGS. 18 and 19 provide NavBars 78 and DataLists 76 that present the results of these automated system tests.

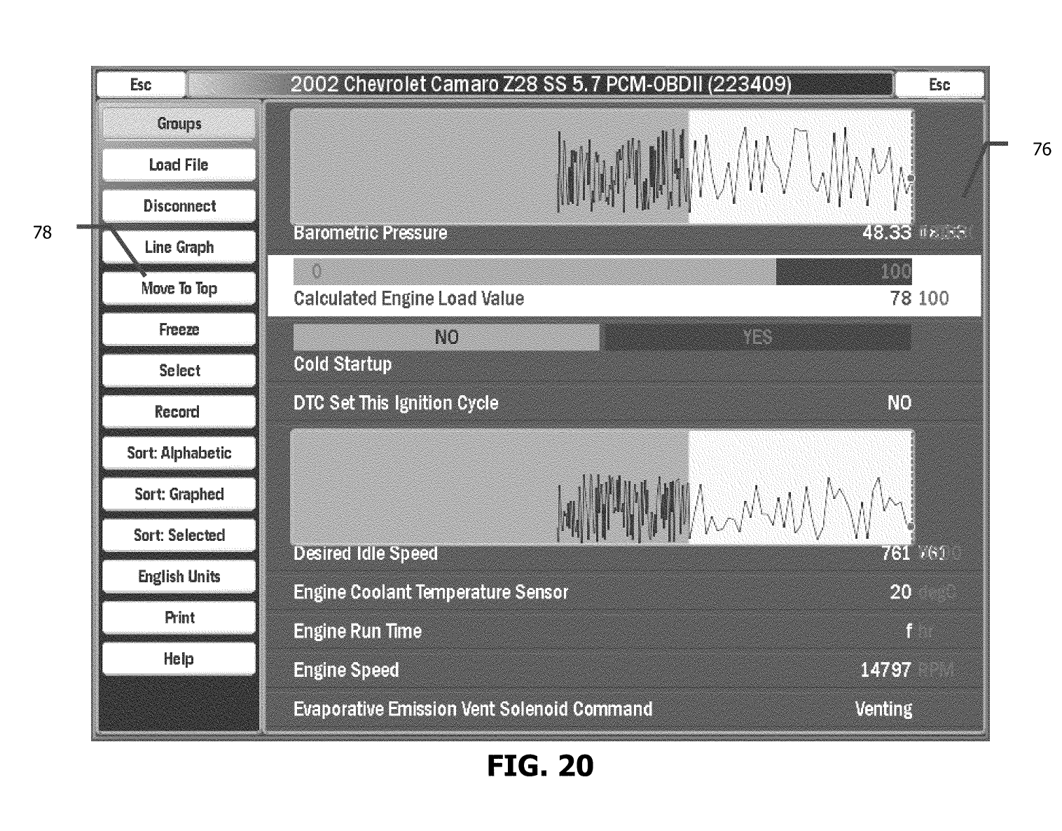

FIG. 20 illustrates a NavBar 78 and DataList 76 associated with the “Datastream” diagnostic function. Data received from the vehicle is continuously displayed to the technician, and graphs may be included in the portion of the window occupied by the DataList 76. As before, the left scroll ring input device 20 controls the selection of the navigation buttons within the NavBar 78, while the right scroll ring input device 20 controls the selection of the DataList 76 items.

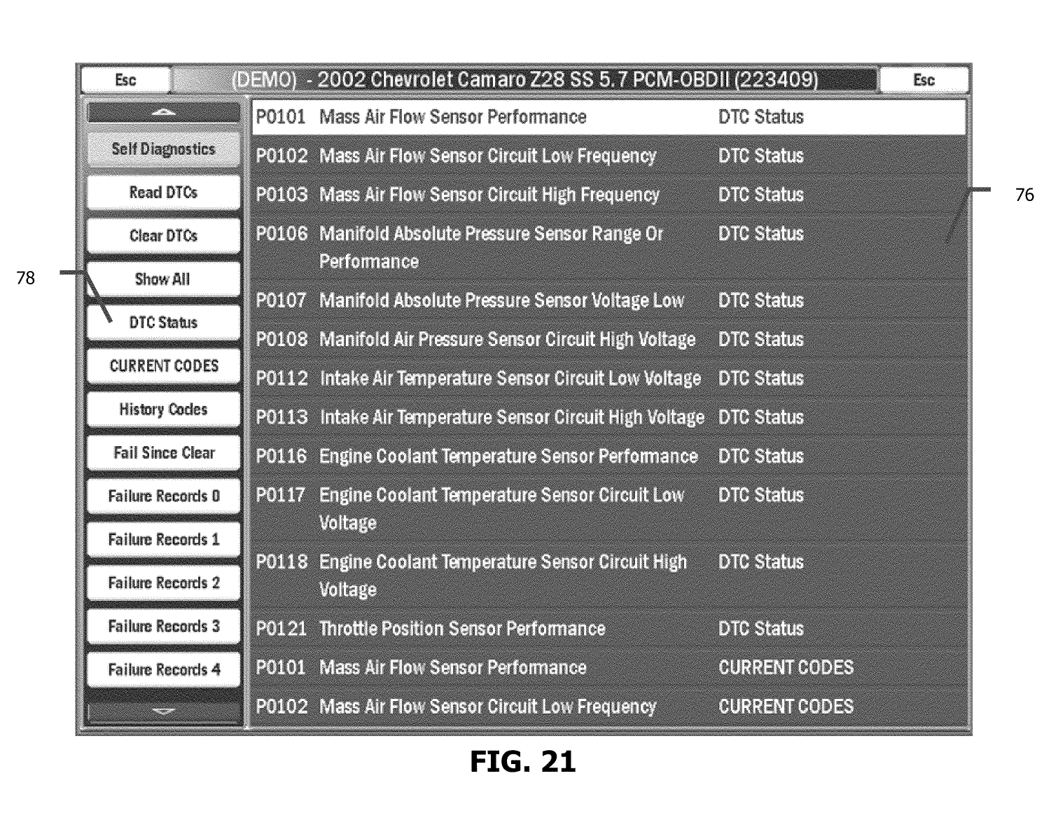

FIG. 21 illustrates a NavBar 78 and DataList 76 associated with the “Diagnostic Trouble Codes” diagnostic function. A list of trouble codes received from the vehicle is displayed in the DataList 76 portion of the window. In one embodiment, prior to the technician's selection of the “Read DTCs” navigation button, the DataList 76 is empty and the NavBar 78 only displays the top three navigation buttons. After the codes have been read, the NavBar 78 displays additional buttons that provide contextual navigation links to filter the display by type (e.g., “CURRENT CODES”), navigate to an information asset, etc.

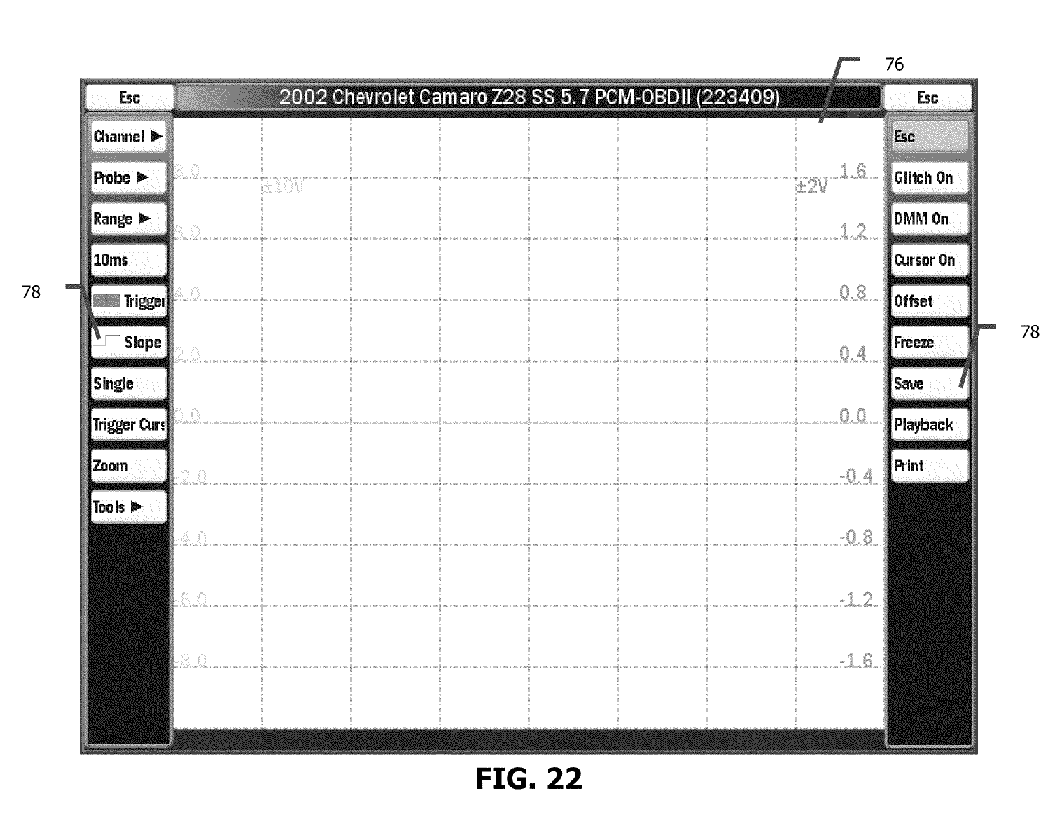

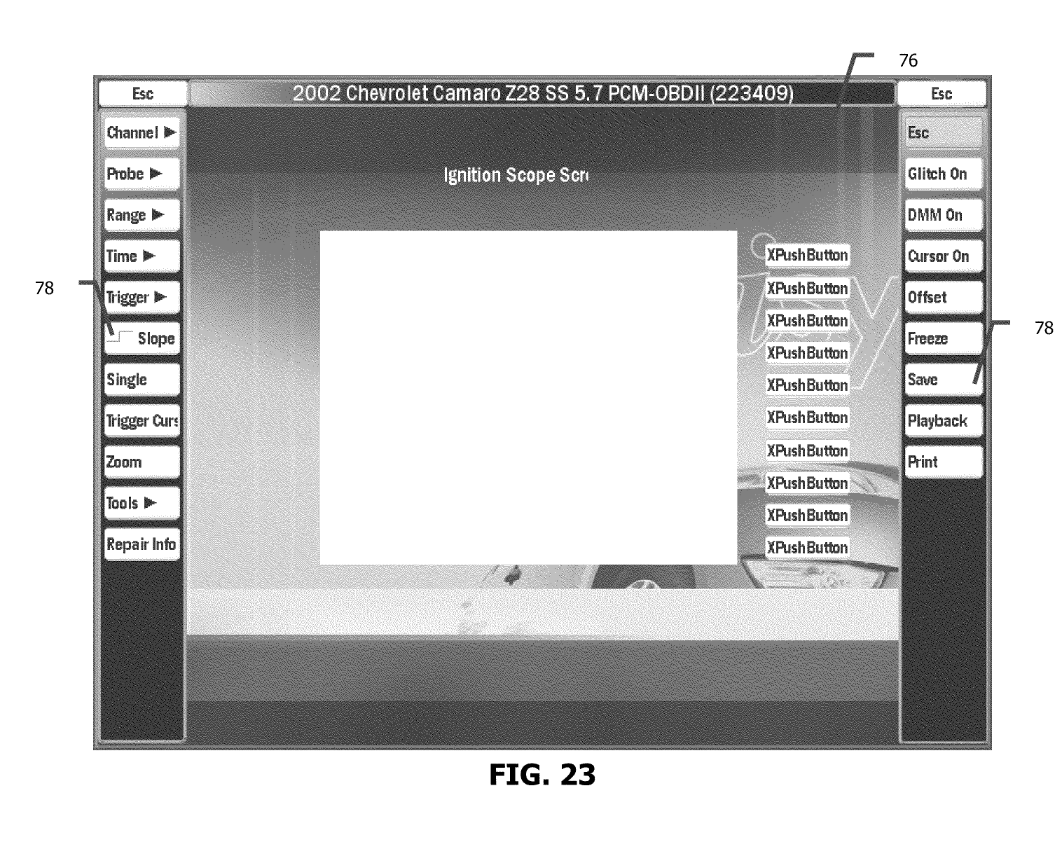

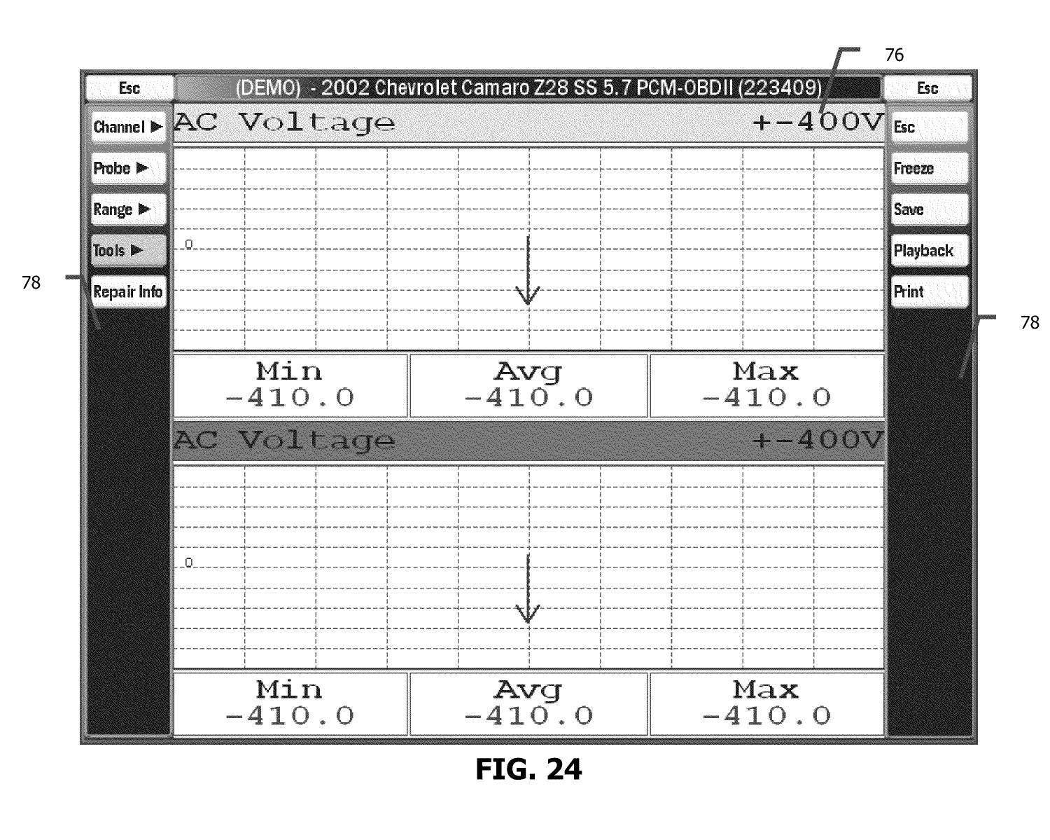

FIGS. 22, 23, 24 and 25 illustrate NavBars 78 and graphs associated with the “Scope” diagnostic function. FIGS. 22 and 23 include a central graph region bordered by a NavBar 78 on each side; in these embodiments, the left scroll ring input device 20 controls the left NavBar 78, while the right scroll ring input device 20 controls the right NavBar 78. FIG. 23 depicts additional push buttons immediately to the right of the central graph region; these buttons may be controlled by the either scroll ring input device 20. FIG. 24 similarly depicts a digital multi-meter, while FIG. 25 illustrates a second Wheel Menu 88 that is accessed by selecting a navigation button with an arrowhead pointing to the right (e.g., “Tools”). The second Wheel Menu 88 provides, for example, further options related to the central graph region, and is controlled by the left scroll ring input device 20.

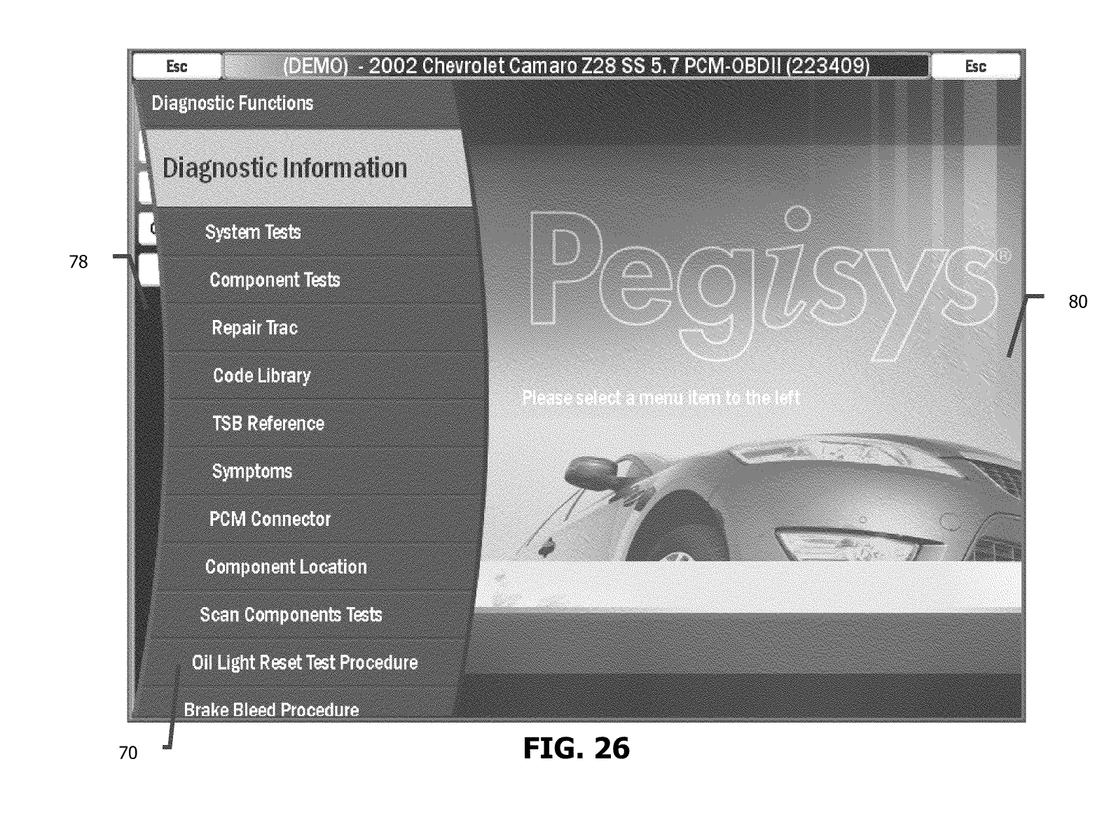

FIG. 26 depicts at least some of those second layer menu items 86 associated with, and depending from, the selected “Diagnostic Information” menu item. These second layer menu items 86 represent particular diagnostic information that is available to the technician, and, in one embodiment, the second layer menu items 86 may change depending upon the selected vehicle.

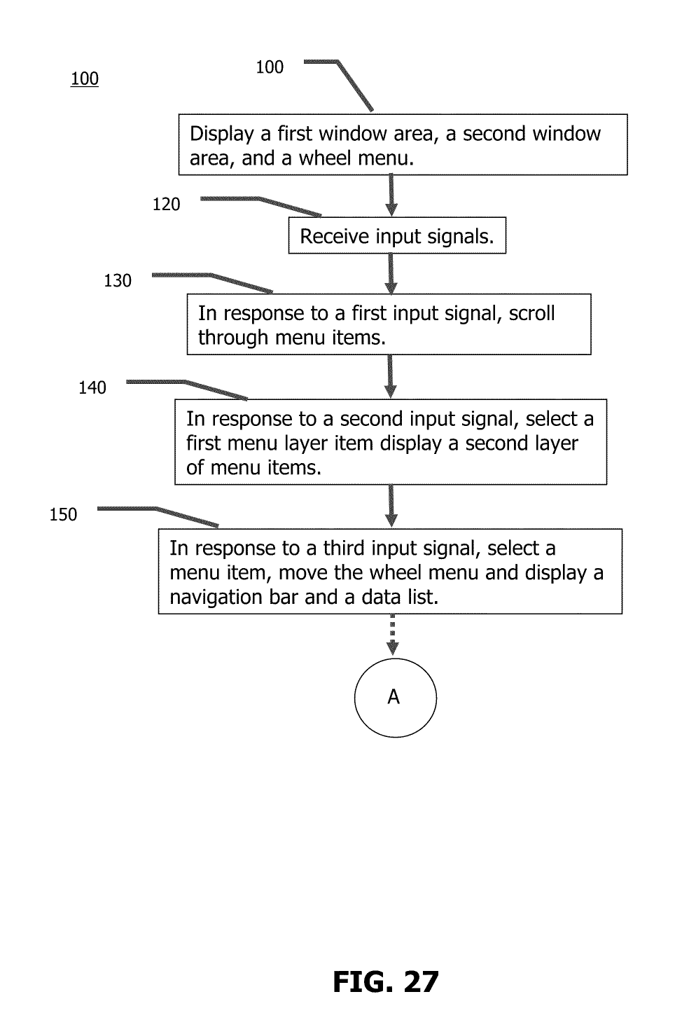

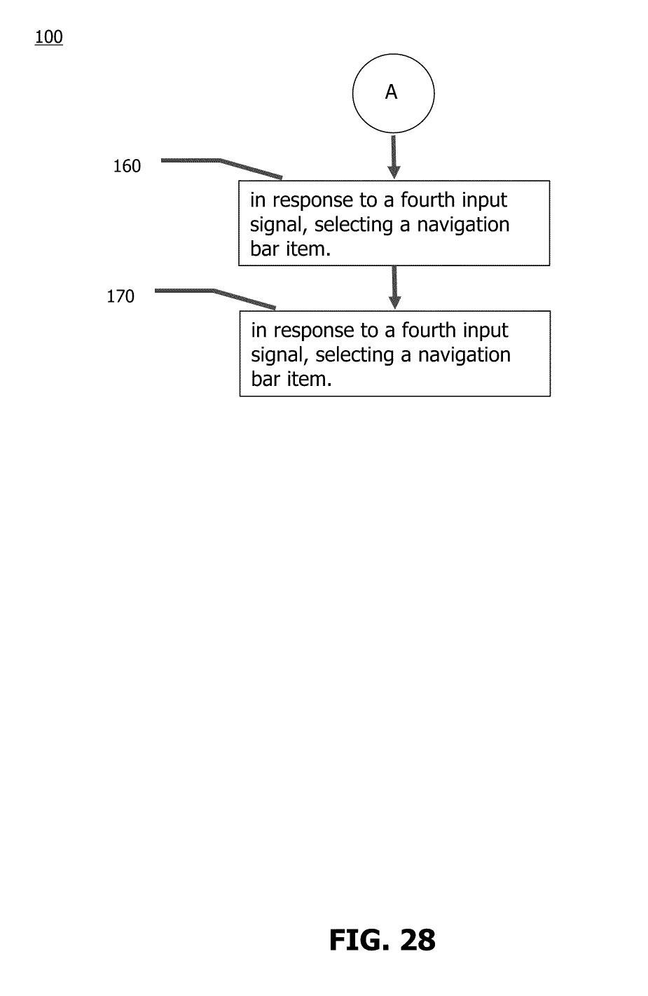

FIG. 27 illustrates the steps that may be followed in a method to display a GUI for a portable diagnostic device 100 in accordance with an embodiment of the present invention.

The method may begin by displaying a first window area 74, displaying a second window area 72, and displaying a Wheel Menu 70 in which menu items 82 are displayed to selectively overlay at least a portion of the first and second window areas 74, 72 (step 110). This step generally steps up the display having the Wheel Menu 70 in a first position where the Wheel Menu 70 is visible and useable to the user. In this position the Wheel Menu 70 may overlay at least portions of the other parts of the display. For example, the Wheel Menu 70 may be displayed over the majority of the first window area 74. The Wheel Menu 70 may also overlay part or all of the second window area 72.

With the Wheel Menu 70 in the first position described above, the portable diagnostic device 10 can receive input signals from the input devices 20 for manipulating the graphical user interface (step 120). The signals can be received by the portable diagnostic device 10 to manipulate the GUI and implement functions of the portable diagnostic device 10 through the GUI.

There are a number of signals which may, in response to the signals, cause the portable diagnostic device to manipulate the GUI. A first input signal from the left scroll ring input device 20 may cause a scrolling response, where the portable diagnostic device 10 responds by scrolling through the menu items 82 of the Wheel Menu 70 and indicating focus on one menu item 82 (step 130). Scrolling through the menu items 82 of the Wheel Menu 70 may occur in any direction or order. As scrolling through the menu items 82 occurs, which menu item 82 is in focus can be indicated in a number of different visual cues, for example, changing the color of the menu item 82, changing the appearance of the menu item 82 to look like a depressed or raised button, moving the menu item 82 to look like it's separate from the rest of the Wheel Menu 70. Aural cues like making the menu item 82 audible may also be used.

A second input signal from the left scroll ring input device 20 may cause the portable diagnostic device 10 to respond by selecting a first layer menu item 84 having a related second layer of menu items 86 and displaying the second layer of menu items 86 within the Wheel Menu 70 along with and visually distinguished from the first layer menu items 84 (step 140). In some instances, the menu items 82 may be a first layer of menu items 84. In such a case, the first layer menu items 84 may each be associated with a second layer of menu items 86 instead of a related screen with a navigation bar 78 and a data list 76. Thus, when the first layer menu item 84 is selected the display may show the related second layer menu items 86. The second menu layer items 86 may be displayed in the Wheel Menu 70 and be visually distinct from the first layer menu items 84. The visual distinction may be accomplished in a number of ways. Changing the color of the second menu layer items 86, changing the appearance of the second menu layer items 86 to look like a depressed or raised button, moving the second menu layer items 86 to look like it's separate from the rest of the Wheel Menu 70, and indenting the second menu layer items 86 are all options for visually distinguishing them from the first menu layer items 84.

A third input signal from the left input scrolling device 20 for manipulating the GUI may cause the portable vehicle diagnostic device 10 to respond by selecting one menu item 82 and moving the Wheel Menu 70 from the first position to a second position and displaying the navigation bar 78 in the first window area 74 of the display and the data list 76 in the second window area 72 of the display 28 (step 140). When a menu item 82 is selected, the GUI will display the screen related to the menu item selection and moves the Wheel Menu 70 to a second position such that the Wheel Menu 70 is located in a manner that does not obstruct the view of the items in the navigation bar 78 and the items in the data list 76. The Wheel Menu 70 may be removed from the display entirely, or it may be hidden such that a portion of the edge of the Wheel Menu 70 is still visible. A screen related to a selected menu item 82 may include the appropriate navigation bar 78 displayed in the first window area 74 and the appropriate data list 76 in the second window area 72.

Another embodiment of the current invention may include a fourth input signal from the left input scrolling device 20 causing the portable vehicle diagnostic device 10 to respond by selecting a navigation bar item when the Wheel Menu 70 is in the second position and displaying a data list 76 related to the selected navigation bar 78 item in the second window area 72 (step 160). Like the Wheel Menu 70, the navigation bar 78 may contain interactive item that when selected alter the display of the GUI. In some instances an item of the navigation bar 78 may have a related data list 76. When the item of the navigation bar 78 is selected, then the GUI will display the related data list 76 in the second window area 72. Like above, this data list 786 may be formatted as a grid display of icons.

Further, an embodiment ma include a fifth input signal from the right scroll ring input device 20 resulting in the vehicle diagnostic device 10 to select an item from the data list 76 (step 170). Selection of a data list item ma cause the vehicle diagnostic device to display further information related the selected item. This information may be displayed in either part or all of the second window area 72, or even the entire display area.

In some instances displaying a second window area 72 (step 110) may include the formatting the data list 76 to present a grid display of icons as shown in FIG. 9.

Moving the Wheel Menu 70 (step 150) further includes the step of slideably moving the Wheel Menu 70 on the display 28 such that the Wheel Menu 70 is at least partially hidden on the display 28 in the second position (step 138). As explained above, when the Wheel Menu 70 is moved to its second position, the Wheel Menu 70 may be only partially hidden instead of completely removed from view. For example, the Wheel Menu 70 may be moved off to a side of the display 28 such that only a portion of the edge of the Wheel Menu 70 is visible. Another example may be to shrink the Wheel Menu 70 such that its shape is visible, but the details of the menu items 82 within the Wheel Menu 70 are hidden. In the instance where the Wheel Menu 70 is moved to a side of the display 28, this may be accomplished simply by making it jump from fully displayed to partially or completely hidden, or there may be an animation associated with moving the Wheel Menu 70. Such animations may include, for example, sliding, sinking, raising, or wiping. The Wheel Menu 70 may be move back into view in the same manner.

Other embodiments of the current invention displaying the second window area 72 (step 110) may include formatting the data list 76 to display an image. In some instances the image may be an info screen 80 as shown in FIGS. 8, 16, 17, and 26. Other embodiments include the image to be a graphical representation of data as shown in FIGS. 20 and 22-25.

Still, in further embodiments of the present invention displaying (step 110) may include displaying a third window area in which a second navigation bar 78 is displayed. This second navigation bar 78 may include all of the same properties as previously described for the navigation bar 78.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A graphical user interface for a portable diagnostic device, comprising:
a first window area to display a navigation bar;
a second window area to display a data list having a plurality of selectable items; and
a wheel menu, having a first position selectively overlaying at least a portion of the first and second window areas, to display a plurality of selectable menu items, the menu items being selected in response to commands received from a first scroll ring input device when overlaying the portions of the window areas.

2. The graphical user interface of claim 1, wherein the data list comprises a grid display of icons.

3. The graphical user interface of claim 1, wherein the wheel menu comprises:
a first layer of menu items; and
a second position being at least partially hidden on the display.

4. The graphical user interface of claim 3, wherein the wheel menu further comprises a second layer of menu items related to a menu item of the first list of menu items to be displayed upon selection of the related menu item and visually distinct from the first layer of menu items.

5. The graphical user interface of claim 3, wherein the items of the navigation bar are selected in response to commands received from the multipurpose input device when the wheel menu is in the second position.

6. The graphical user interface of claim 3, wherein the wheel menu moves in a sliding motion when changing between the first and second position.

7. The graphical user interface of claim 1, wherein the second window area displays an image; and
a third window area displays a second navigation bar.

8. The graphical user interface of claim 1, wherein the selectable items of the data list are selected in response to commands received from a second scroll ring input device

9. A method for displaying a graphical user interface for a portable diagnostic device, comprising:
displaying a first window area, a second window area, and a wheel menu including menu items that when displayed, in a first position, selectively overlays at least a portion of the first and second window areas;
receiving input signals from a first scroll ring input device for manipulating the graphical user interface;
in response to a first input signal from the first scroll ring input device, scrolling through menu items of the wheel menu and indicating focus on one menu item;
in response to a second input signal from the first scroll ring input device, selecting a first menu layer item and displaying a second layer of menu items within the wheel menu along with and visually distinguished from the first layer menu items; and
in response to a third input signal from the first scroll ring input device, moving the wheel menu from the first position to a second position and displaying a navigation bar in the first window area of the display and a data list in the second window area of the display.

10. The method of claim 9, wherein displaying a second window area further includes formatting the data list to present a grid display of icons.

11. The method of claim 9, further comprising:
in response to a fourth input signal from the first scroll ring input device, selecting a navigation bar item when the wheel menu is in the second position and displaying a data list related to the selected navigation bar item in the second window area; and
in response to a fifth input signal from the second scroll ring input device, selecting a data list item.

12. The method of claim 9, wherein moving the wheel menu further comprises slideably moving the wheel menu on the display and positioning the wheel menu such that it is at least partially hidden on the display in the second position and in response to a sixth input signal, slideably moving the wheel menu from the second position to the first position to selectively overlay at least a portion of the first window are having a navigation bar and second window area having a data list.

13. The method of claim 9, wherein displaying the second window area further includes formatting the data list to display an image.

14. The method of claim 9, wherein displaying further comprises displaying a third window area in which a second navigation bar is displayed.

15. A portable diagnostic device, comprising:
a display to present a graphical user interface including a first window area including a navigation bar, a second window area including a data list, and a wheel menu that when displayed, in a first position, selectively overlays at least a portion of the first and second window areas and include menu items;
a first scroll ring input device to generate user input signals to selectively interact with the wheel menu and the navigation bar;
a memory to store graphical user interface software instructions; and
a processor to interpret the instructions stored on the memory and the user input signals generated by the first and second scroll ring input devices.

16. The portable diagnostic device of claim 15, wherein the display further presents the graphical user interface having the data list being a grid display of icons.

17. The portable diagnostic device of claim 15, wherein the display further presents the graphical user interface having the wheel menu containing a first layer of menu items; and
a second layer of menu items related to a menu item of the first list of menu items to be displayed upon selection of the related menu item and visually distinct from the first layer of menu items.

18. The portable diagnostic device of claim 15, wherein the display further presents the graphical user interface having the wheel menu disposed in a second position being at least partially hidden on the display, and the items of the navigation bar selectable in response to commands received from the first scroll ring input device when the wheel menu is in the second position.

19. The portable diagnostic device of claim 18, wherein the display further presents the graphical user interface having the wheel menu to move in a sliding motion when changing between the first and second position.

20. The portable diagnostic device of claim 15, wherein the display further presents the graphical user interface having the second window area to display an image; and
a third window area to display a second navigation bar.

21. The portable diagnostic device of claim 15, wherein the input devices further comprise a touch screen.

22. The portable diagnostic device of claim 15, further comprising:
a second scroll ring input device to generate user input signals to interact with the data list.
